(19) United States
(12) Patent Application Publication
(10) Pub. No.: US 2026/0219452 A1
(43) Pub. Date: Jul. 30, 2026

(54) FIBER STRIPPER WITH HEATED ROLLERS

(71) Applicant: CommScope Technologies LLC, Claremont, NC (US)

(72) Inventors: Jozef Christiaan Mathieu VERSLEEGERS, Bree (BE); Thierry Mike DECLERCK, Kumtich (BE); Walter MATTHEUS, Wijgmaal (BE); Alfons Rudi HERMANS, Sint-Truiden (BE); Ruben L. WICOT, Beerzel (BE)

(73) Assignee: CommScope Technologies LLC, Claremont, NC (US)

(21) Appl. No.: 19/147,632

(22) PCT Filed: Jan. 12, 2024
(86) PCT No.: PCT/US2024/011456

§ 371 Date: Jul. 11, 2025

Related U.S. Application Data
(60) Provisional application No. 63/439,012, filed on Jan. 13, 2023.

(51) Int. Cl. G02B 6/245

(52) U.S. Cl. CPC G02B 6/245

(57) ABSTRACT

The present disclosure relates to a stripping machine which includes heated rollers and stripping tapes to remove coating from optical fibers with high precision.

### CROSS-REFERENCE TO RELATED APPLICATIONS

This application is being filed on Jan. 12, 2024, as a PCT International Application and claims the benefit of U.S. Provisional Application No. 63/439,012 filed on Jan. 13, 2023, the disclosure of which is hereby incorporated by reference in its entirety.

### TECHNICAL FIELD

The present disclosure relates generally to fiber optic equipment. More particularly to devices for stripping optical fibers.

### BACKGROUND

Fiber stripping devices are known for removing coatings from optical fibers. An example fiber stripping device which utilizes blades and tapes to provide fiber stripping is disclosed in U.S. Pat. No. 10,788,625.

### SUMMARY

Aspects of the present disclosure relates to a stripping machine including heated rollers and stripping tapes configured remove a coating from an optical fiber. In certain examples, a heater is provided adjacent to the heated rollers for pre-heating a length of the optical fiber desired to be stripped.

Another aspect of the present disclosure relates to a fiber stripping device for stripping a coating from an optical fiber. The fiber stripping device includes first and second heated rollers separated by a gap. The first and second heated rollers define a mouth of the fiber stripping device. The fiber stripping device also includes first and second tapes respectively routed about the first and second heated rollers. The first and second tapes are configured to receive the optical fiber between the first and second tapes when the optical fiber is inserted along a fiber insertion/withdrawal axis in a fiber insertion direction into the mouth of the fiber stripping device. The first and second heated rollers are configured to be pressed together to create a fiber pinch location at the gap with the fiber pinch location being defined between portions of the first and second tapes. The first and second tapes are respectively moveable along tape routing paths that extend along the fiber insertion/withdrawal orientation. The fiber stripping device also includes a tape puller for pulling the first and second tapes along the tape routing paths in the fiber insertion direction.

Another aspect of the present disclosure relates to a method for stripping a coating from an optical fiber. The optical fiber has a distal end. The method includes inserting the optical fiber in a fiber insertion direction to an inserted position between the first and second tapes. The method also includes pressing the inserted optical fiber between the first and second tapes at a pinch location using opposed heated rollers. The pinch location is offset from the distal end of the optical fiber by a desired strip length. The method further includes moving the first and second tapes relative to the optical fiber in the fiber insertion direction toward the distal end of the optical fiber while concurrently pulling the inserted optical fiber from the inserted position in a fiber withdrawal direction opposite from fiber insertion direction thereby causing the coating to be stripped from a cladding of the optical fiber by the first and second tapes. The first and second tapes are pressed against the optical fiber at the pinch location by the opposed heated rollers during fiber withdrawal.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a cross-sectional view of an optical fiber adapted to be stripped by a fiber stripping device in accordance with the principles of the present disclosure;

FIG. 2 is a cross-sectional view of an optical fiber ribbon adapted to be stripped by a fiber stripping device in accordance with the principles of the present disclosure;

FIG. 3 is a cross-sectional view of another optical fiber ribbon adapted to be stripped by a fiber stripping device in accordance with the principles of the present disclosure;

FIG. 4 is a perspective view of the optical fiber stripper in accordance with the present disclosure;

FIG. 5 diagrams the fiber stripper of FIG. 4 prior to insertion of an optical fiber;

FIG. 6 diagrams the fiber stripper of FIG. 4 with the optical fiber inserted therein;

FIG. 7 diagrams stripping of coating from the optical fiber using the fiber stripper of FIG. 4;

FIG. 8 diagrams the fiber stripper of FIG. 4 after stripping of coating from the optical fiber;

FIG. 9 is an enlarged view of a portion of FIG. 4; and

FIG. 10 shows the fiber stripping device of FIG. 4 with the addition of a diverter.

### DETAILED DESCRIPTION

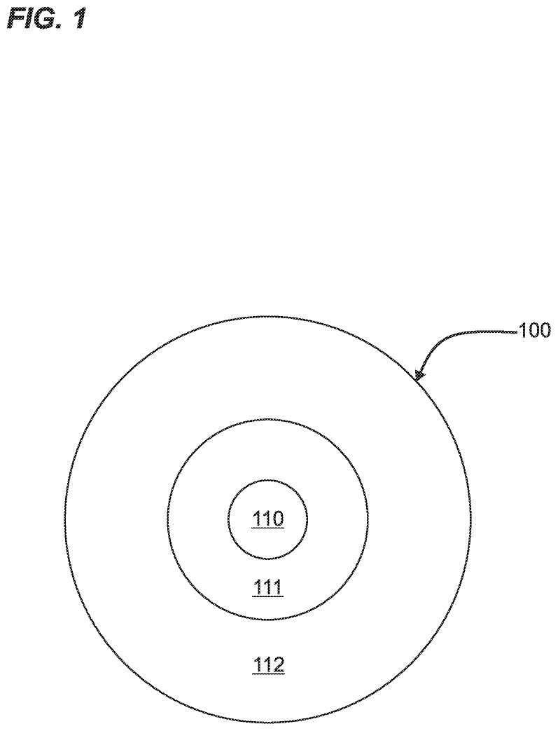

FIG. 1 is a cross-sectional view of an optical fiber 100. In some embodiments optical fiber 100 includes three distinct concentric layers: core 110, cladding 111, and coating 112. Core 110 is the innermost layer of optical fiber 100 and typically has a composition including glass. In some examples such as single mode fibers, the core 110 can have a diameter of around 10 microns. The core 110 functions as a channel through which information in the form of light may be transmitted along the length of optical fiber 100.

The cladding 111 often has a composition that includes glass and is configured to surround the core 110. In some examples such as single mode fibers, the cladding 111 can have an outer diameter of around 125 microns. The cladding 111 preferably has an index of refraction different from an index of refraction of the core 110, and as such aids in the transmission of light through the core 110 of optical fiber 100 via total internal reflection.

The coating 112 surrounds and protects the cladding 111 and often has a polymeric composition. The coating 112 protects the cladding 111 and the core 110 and helps prevent breakage of the optical fiber during handling and usage. In some embodiments, coating 112 has a composition that includes acrylate or another appropriate polymeric material. In some embodiments, coating 112 has an outer diameter of 250 microns or less. It will be appreciated that the various dimensions provided for the optical fiber are provided by way of example, and that other dimensions are also applicable.

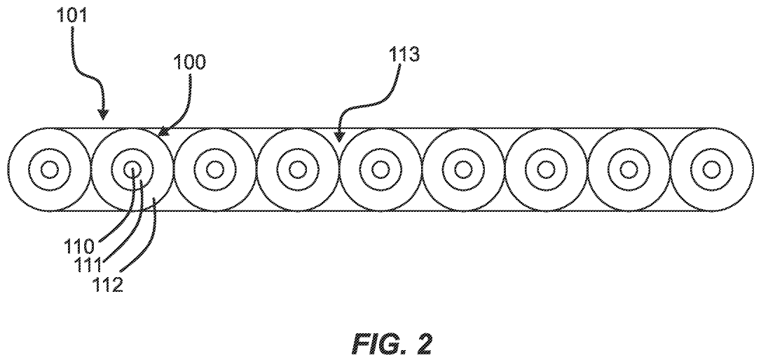

The optical fiber can be arranged as a single optical fiber or can be grouped in a parallel arrangement as a fiber ribbon. FIG. 2 is a cross-sectional view of an optical fiber ribbon 101 which includes multiple optical fibers 100 arranged in parallel. In some embodiments the optical fiber ribbon 101 is comprised of multiple optical fibers 100 joined together by the application of an additional coating layer 113 (e.g., matrix layer, binding layer) of acrylate or another appropriate polymeric material.

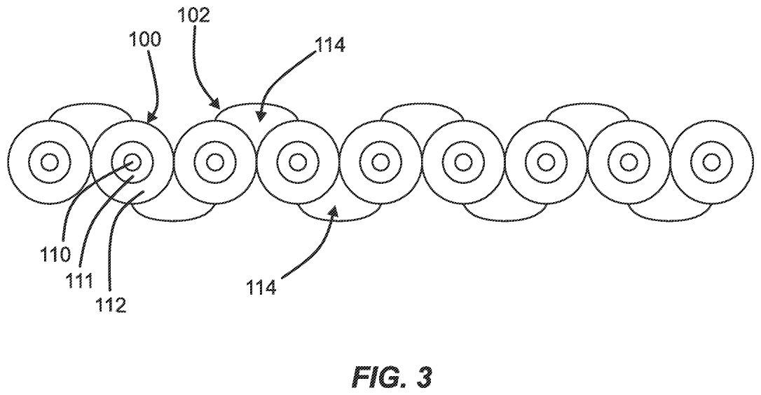

FIG. 3 is a cross-sectional view of an alternative optical fiber ribbon 102 configured as a rollable fiber ribbon. As depicted, the fiber ribbon 102 includes multiple optical fibers 100 arranged in parallel and joined by a coating material including discrete fiber connection locations 114 configured to allow the optical fibers 110 to be rolled into a bundle or other shape.

As indicated above, the coating 112 protects the optical fiber and makes the optical fiber more robust. When the coating 112 has been stripped from the cladding 111, the remaining bare fiber can be quite fragile. Such fragility is increased if knicks, breaks or abrasions are present at the exterior surface of the cladding 111. Aspects of the present disclosure relate to a coating stripping system that effectively removes coating from a fiber or fiber ribbon using a heated roller system designed to effectively remove the coating without damaging the cladding 111. Stripped fibers with undamaged claddings are particularly important for applications such as bare fiber (i.e., ferrule-less) optical connectors in which the bare optical fiber is subjected to repeated compressive loading thereby increasing the likelihood of breakage if the cladding is damaged. Examples of bare fiber connectors such as multifiber bare fiber connectors are disclosed in PCT International Publication Nos. WO2021/163063A1 and WO2020/112645A1, which are hereby incorporated by reference in their entireties. Stripped fibers with undamaged or reduced damage claddings are also advantageous for optical fibers subject to optical splicing as well as optical fibers terminated by ferrules.

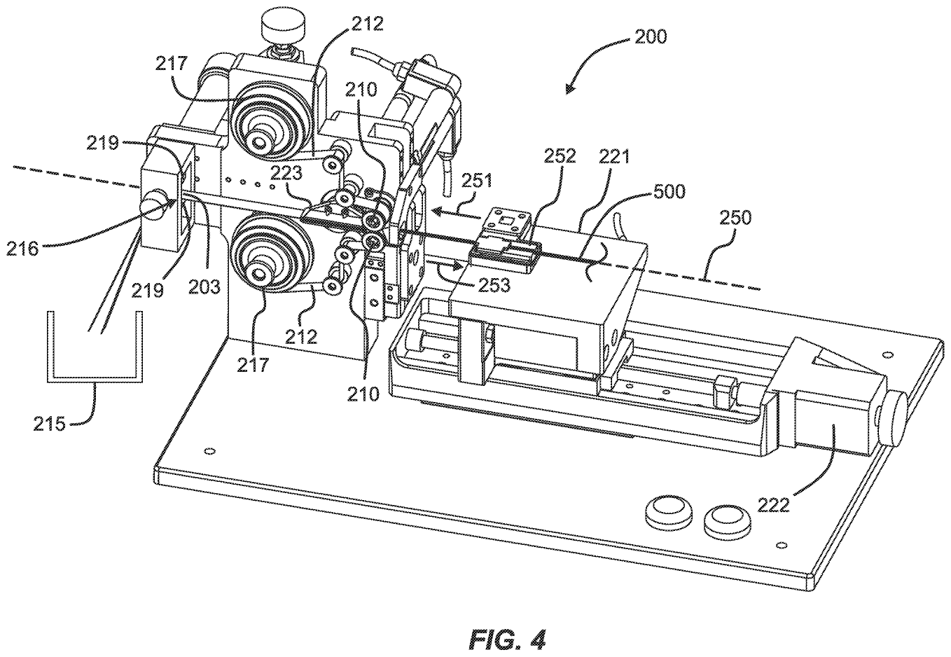

FIG. 4 illustrates a fiber stripping device 200 in accordance with the principles of the present disclosure. The stripping device 200 is configured for stripping the coating 112 from single optic fibers such as the optical fiber 100 of FIG. 1, as well as for stripping the coatings 113, 114 from standard fiber ribbons and rollable fiber ribbons (see FIGS. 2 and 3). The fiber stripping device 200 uses tapes and heated rollers to strip the coatings from the optical fibers or fiber ribbons. As compared to blades, heated rollers are less likely to damage the optical fibers during stripping. Moreover, as compared to blades, rollers don't dull over time and require lower maintenance. Further, it has been found that coating stripping devices using heated rollers in accordance with the present disclosure provide excellent stripping quality and cleanliness and often can provide coating stripping without requiring subsequent processing (e.g., cleaning) to further remove coating debris. Additionally, it has been found that coating stripping devices using heated rollers in accordance with the present disclosure are easy to use and eliminate variation based on the skill of the technician. Certain heated roller stripping devices in accordance with the principles of the present disclosure can be designed for use in a factory setting or can be designed as a field tool for use in stripping optical fibers in the field. Certain heated roller stripping devices in accordance with the principles of the present disclosure can have structure for automatically feeding and removing optical fibers to and from the devices; or alternatively can be configured allow optical fibers to be manually or semi-automatically inserted into and removed from the devices.

The fiber stripping device 200 of FIG. 4 is designed for stripping the coating 112 from the optical fiber 100. The fiber stripping device 200 can also be used to strip the coating layer 112 and well as the additional coating layer 113, 114 from individual optical fibers 100 or optical fiber ribbons 101, 102. In instances where multiple coating layers are present on an optical fiber ribbon 101, 102 (i.e., coating layer 112 and additional coating layer 113 or intermittent coating layer 114) the fiber stripping device 200 may be used to remove each coating layer simultaneously.

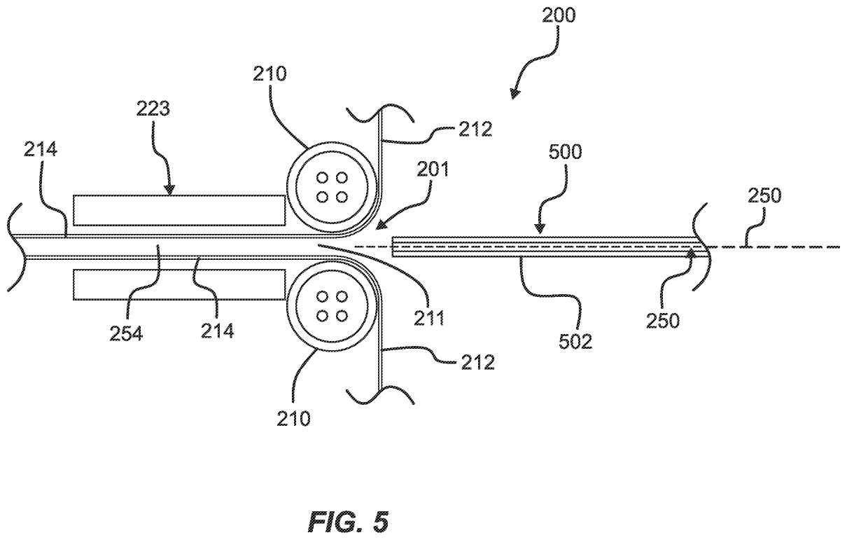

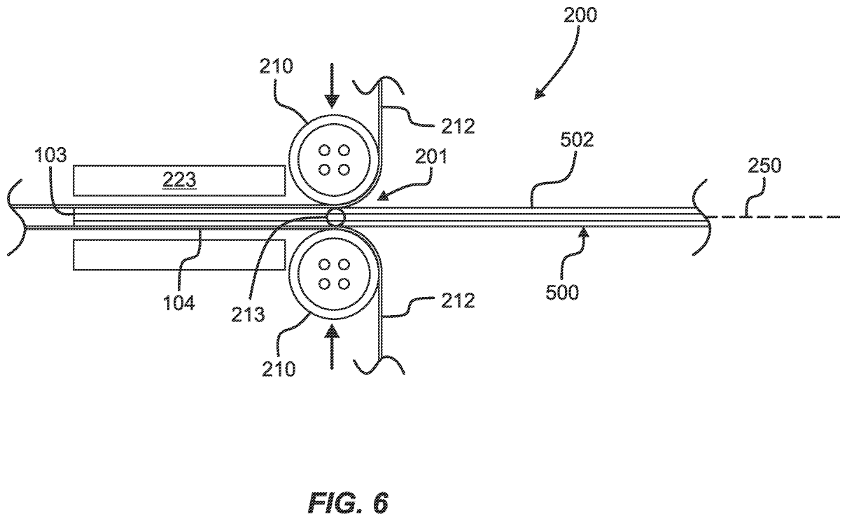

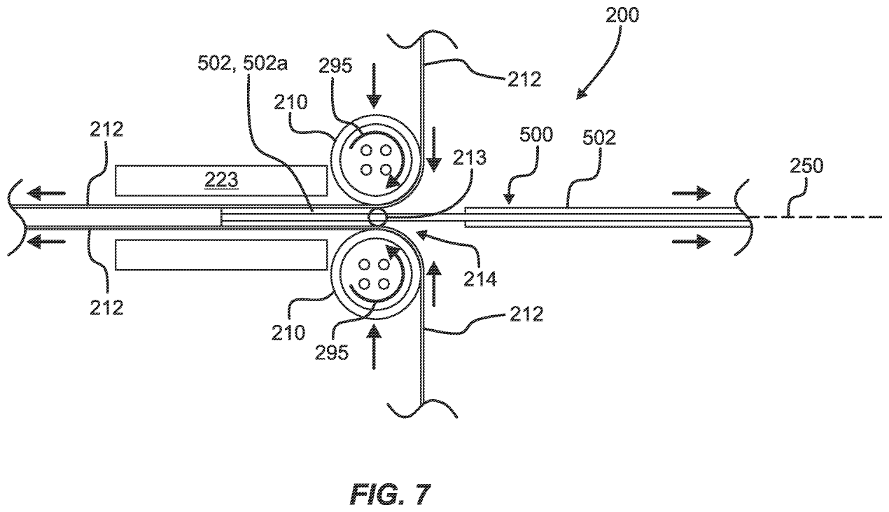

Referring to FIG. 4, the fiber stripping device 200 includes first and second heated rollers 210 separated by a gap 211 (see FIG. 5). The first and second heated rollers 210 define a mouth 201 of the fiber stripping device 200. The fiber stripping device 200 also includes first and second tapes 212 respectively routed about the first and second heated rollers 210. The first and second tapes 212 are configured to receive an optical fiber 500 (e.g., the optical fiber 100 or optical fiber ribbons 101, 102) between the first and second tapes 212 when the optical fiber 500 is inserted along a fiber insertion/withdrawal axis 250 in a fiber insertion direction 251 into the mouth 201 of the fiber stripping device 200. The first and second heated rollers 210 are configured to be pressed together to create a fiber pinch location 213 (circled at FIGS. 6 and 7) at the gap 211 with the fiber pinch location 213 being defined between portions of the first and second tapes 212. The first and second tapes 212 are respectively moveable along tape routing paths 214 (see FIG. 5) that extend along the fiber insertion/withdrawal axis 250 from the first and second heated rollers 210 toward a tape collection location 215 (e.g., a bin). Furthermore, the fiber stripping device 200 includes a tape puller 216 for pulling the first and second tapes 212 along the tape routing paths 214 in the fiber insertion direction 251 from the first and second heated rollers 212 toward the fiber collection location 215. The fiber stripping device 200 further includes a heater 223 adjacent to the heated rollers 210 for pre-heating a length of the optical fiber 500 desired to be stripped when the optical fiber is at an inserted position with respect to the fiber stripping device 200.

In some embodiments, first and second heated rollers 210 are not motorized but are free-rolling and are rotated via contact with the tapes 212. In other examples, one or both of the heated rollers 210 can be driven rollers. The heated rollers 210 can be pressed together and moved apart by an actuator such as one or more pneumatic cylinders. In other examples, the heated rollers can be forced together by a spring or spring arrangement or other type of actuator (e.g., a solenoid, a hydraulic actuator, etc.). In some embodiments, a moveable one of the first or second heated rollers 210 is actively pushed toward a stationary one of the rollers 210 by an actuator, in other embodiments, both of the first and second heated rollers 210 may be pushed actively by a separate designated actuators. In some examples, the heated rollers 210 can have a heat conductive construction (e.g., a metal material such as copper) and can include heating elements such as resistive heating elements for heating the heat conductive construction. The heater 223 can include heating plates between which the tapes 212 extend and between which a length of the optical fiber 500 desired to be stripped is located when the optical fiber 500 is at an inserted position with respect to the fiber stripping device 200 (e.g., when the optical fiber 500 is inserted through the mouth of the fiber stripping device 200). The heating plates can each have a heat conductive construction and can be heated by resistive heating elements. The optical fiber 500 can be pre-heated by radiant heat from the heater 223.

The first and second tapes 212 are supplied respectively by first and second supply spools 217. Furthermore, in some embodiments tape puller 216 of fiber stripping device 200 includes a pinch roller arrangement including first and second pinch rollers 219 that define a nip 203 between which the first and second tapes 212 are routed, wherein at least one of the first and second pinch rollers 219 is a driven roller.

In some embodiments, first and second tapes 212 are single use tapes designed for easy exchange and disposal. In other examples, the tapes may be re-spooled and re-used. In certain examples, the tapes 212 can have a fabric/textile construction and can include a cloth or paper construction. In certain examples, the tapes 212 can have a fibrous construction such as a woven or non-woven fibrous construction. During use, the tapes are preferably dry. Preferably the tapes do not include material that may adhere to the fibers during stripping. In some embodiments tapes may be wetted with an appropriate material (e.g., an alcohol).

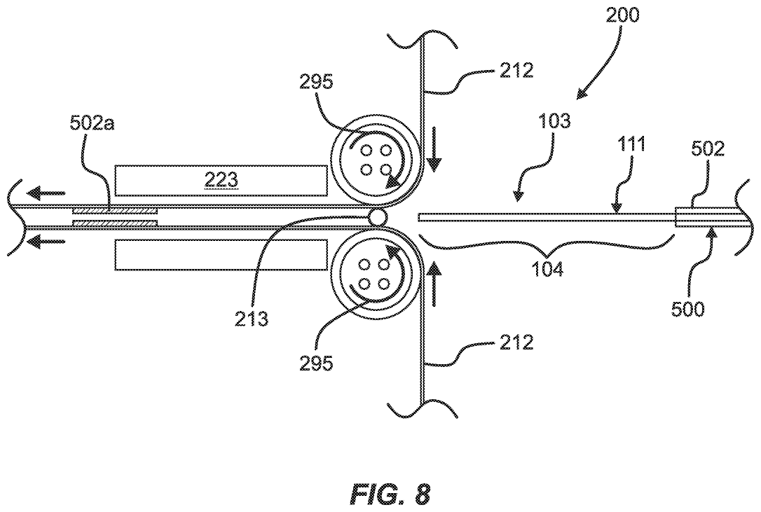

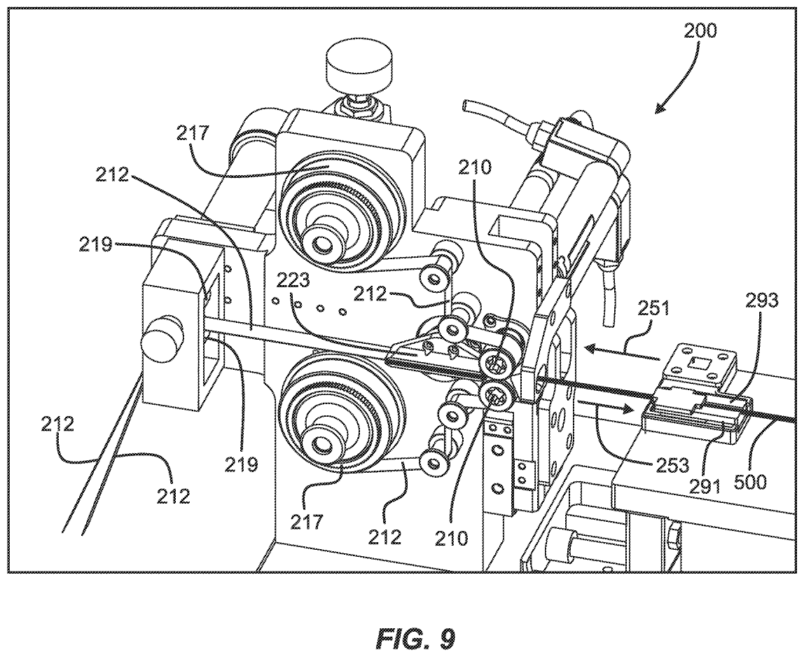

In some embodiments, fiber stripping device 200, includes a carrier 221 for supporting the optical fiber 500 at a position 252 along the fiber insertion/withdrawal axis 250. As depicted, the carrier 221 includes a station defining a clip mounting location 291 (see FIG. 9) for receiving a fiber holding clip 293 adapted to hold the optical fiber 500. As depicted, the optical fiber 500 is shown as a fiber ribbon clamped within the fiber holding clip 293 with a free end portion of the optical fiber 500 projection distally beyond the clip 293. The fiber stripping device 200 also includes an actuator 222 (see FIG. 4) for moving the carrier 221 along fiber insertion/withdrawal axis 250. For example, the actuator 222 can move the carrier 221 in the fiber insertion direction 251 to insert the distal end portion 103 of the optical fiber 500 through the mouth of the fiber stripping device 200 to the inserted position while the rollers 210 are in an open position. Once the distal end portion 103 of the optical fiber 500 has been inserted through the mouth to the inserted position, the rollers 210 (which are heated) can be pressed together to press the fiber 500 between the tapes 212 at the pinch location/gap and a coating 502 (e.g., coating 112, 113 and/or 114) on the distal end portion 103 of the optical fiber 500 can be pre-heated by the heater 223. Once the distal end portion 103 of the optical fiber 500 has been pre-heated, the tapes 212 can be pulled by the tape puller in the fiber insertion direction 251 while the optical fiber 500 is pulled by the carrier 221 in a fiber withdrawal direction 253 opposite from the fiber insertion direction 251. Pulling of the tapes 212 in the fiber insertion direction 251 causes rotation of the rollers 210 as shown by arrows 295 (see FIGS. 7 and 8). The rollers 210 remain pressed together as the tapes 212 are pulled in the fiber insertion direction 251 and the optical fiber 500 is pulled in the withdrawal direction 253 causing the tapes 212 to strip the coating 502 from the optical fiber 500. Stripped coating 502a (see FIG. 8) is collected on and adheres to the tapes 212 such that the tapes 212 carry the stripped coating 502a away from the distal end portion 103 of the optical fiber 500. In one example, pulling of the optical fiber 500 in the withdrawal direction 253 can be initiated concurrently with pulling the tapes 212 in the fiber insertion direction 251. In another example, pulling of the optical fiber 500 in the fiber withdrawal direction 253 can be initiated slightly after initiation of pulling the tapes 212 in the fiber insertion direction 251.

As depicted, the heater 223 is positioned adjacent to the first and second heated rollers 210 and the tape routing path 214 extends through the heater 223. The heater 223 is positioned such that heater 223 coincides with a fiber insertion region 254 that is adapted to receive the distal end portion 103 of an optical fiber 500 inserted through the gap 211 and that coincides with the inserted position the optical fiber 500.

FIGS. 5-8 illustrate a method for stripping the coating 502 from the optical fiber 500. FIG. 5 illustrates the initial step in using fiber stripping device 200 wherein optical fiber 500 is aligned with mouth 201 of fiber stripping device 200 along the fiber insertion/withdrawal axis 250.

FIG. 6 illustrates the insertion of the distal end 103 of optical fiber 500 through mouth 201 of fiber stripping device 200 along the fiber insertion/withdrawal axis 250. The distal end 103 is passed through the mouth 201 of the fiber stripping device 200 between the first and second tapes 212. Furthermore, the distal end 103 of the optical fiber 500 is threaded between the first and second heated rollers 210 through the gap 211 and along the tape routing paths 214. The distal end portion 103 can then be pre-heated by the heater 223. The first and second heated rollers 210 may then be pressed together, compressing, and heating coating 502. Pinch location 213 may be offset from a distal end of optical fiber 500 by a desired strip length 104. In some embodiments the strip length 104 is preheated by heater 223.

FIG. 7 illustrates the precise removal of coating 502 from the optical fiber 500 by the fiber stripping device 200. The coating 502 is severed at the pinch location 213 by the first and second heated rollers 210. The first and second tapes 212 are pulled along the tape routing paths 214 by first and second driven rollers 219 in the fiber insertion direction 251 and the fiber 500 is pulled in the fiber withdrawal direction 253. The first and second tapes 212 engage and remove the pre-heated coating 502, which has been severed at pinch location 213, along the strip length 104 as the optical fiber 500 is withdrawn from between the rollers 210. First and second heated rollers 210 may be pressed together with variable force depending on the operators' requirements and/or the type of fiber being stripped. The coating 502 is removed from the fiber 500 and carried by with the tapes 212 to the tape collection location 215. FIG. 8 illustrates the end product of method, wherein coating 502 has been removed from strip length 104 exposing cladding 111.

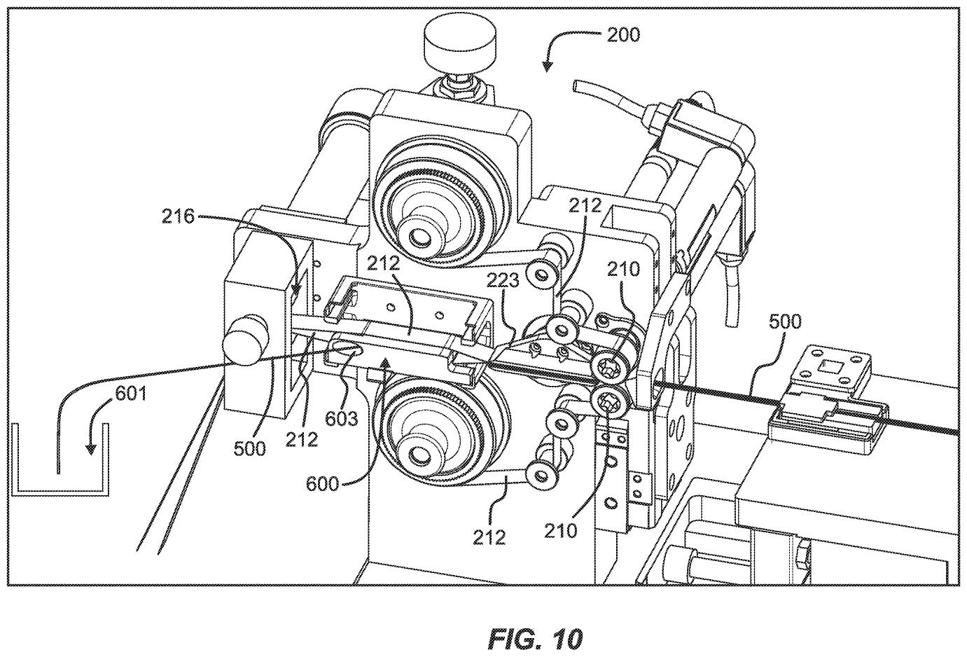

In certain examples, the fiber stripping device 200 can be used to provide a window strip at a mid-span location of the optical fiber 500. To facilitate making the window strip at the mid-span location, a diverter 600 (see FIG. 10) can be positioned adjacent a back side of the heater 223 for separating the first and second tapes 212 and for diverting the optical fiber 500 away from between the tapes 212 as the optical fiber is inserted through the fiber stripping device 200. The fiber 500 is inserted through the gap and the preheating region and through the diverter 600 to a fiber collection region 601 where a length of the optical fiber can be temporarily stored (e.g., spooled, wound or otherwise stored). Insertion can continue until a mid-span location of the optical fiber 500 desired to be stripped coincides with the pre-heating region defined by the heater 223. The heater can then pre-heat the coating at the mid-span location of the fiber and the heated rollers 210 can be pressed towards each other to press the optical fiber between the tapes 212 at the pinch location. The tapes 212 can then be moved in the fiber insertion direction 251 while the optical fiber 500 is pulled in the fiber withdrawal direction 253 through the pressed pinch location to strip the coating 502 from the length of the mid-span location. Once the length of the mid-span location has been stripped, the heated rollers 210 can be separated and the remainder of the inserted fiber can be withdrawn from the fiber stripping device 200. The diverter 600 can include a fiber inlet aligned with the axis 250 for receiving the fiber from the heater 223 and a fiber outlet 603 for laterally directing the fiber 500 away from the axis 250. The body of the diverter 600 can be tapered to facilitate separating the tapes 212.

1. A fiber stripping device for stripping a coating from an optical fiber, the fiber stripping device comprising:
first and second heated rollers separated by a gap, the first and second heated rollers defining a mouth of the fiber stripping device;
first and second tapes respectively routed about the first and second heated rollers, the first and second tapes being configured to receive the optical fiber between the first and second tapes when the optical fiber is inserted along a fiber insertion/withdrawal axis in a fiber insertion direction into the mouth of the fiber stripping device, wherein the first and second heated rollers are configured to be pressed together to create a fiber pinch location at the gap with the fiber pinch location being defined between portions of the first and second tapes, the first and second tapes being respectively moveable along tape routing paths that extend along the fiber insertion/withdrawal orientation; and
a tape puller for pulling the first and second tapes along the tape routing paths in the fiber insertion direction.

2. The fiber stripping device of claim 1, wherein the first and second tapes are supplied respectively by first and second supply spools.

3. The fiber stripping device of claim 1, wherein the tape puller includes a pinch roller arrangement including first and second pinch rollers that define a nip between which the first and second tapes are routed, wherein at least one of the first and second pinch rollers is a driven roller.

4. The fiber stripping device of claim 1, further comprising a carrier for supporting the optical fiber at a position along the fiber insertion/withdrawal axis.

5. The fiber stripping device of claim 4, further comprising an actuator for moving the carrier along the fiber insertion/withdrawal axis.

6. The fiber stripping device of claim 1, further comprising a heater positioned adjacent to the first and second heated rollers, wherein the tape routing path extends through the heater.

7. The fiber stripping device of claim 6, wherein the heater coincides with a fiber insertion region that is adapted to receive a distal end portion of a fiber inserted through the gap.

8. The fiber stripping device 4, wherein the carrier includes a station defining a clip mounting location for receiving a fiber holding clip adapted to hold the optical fiber.

9. The fiber stripping device of claim 8, wherein the optical fiber is one of a plurality of optical fibers arranged in a fiber ribbon, wherein the fiber ribbon is clamped within the fiber holding clip, and wherein the fiber stripping device is configured for stripping coating material from all of the optical fibers of the fiber ribbon.

10. The fiber stripping device of claim 6, further comprising a fiber diverter positioned adjacent to the heater, the fiber diverter being positioned to separate the first and second tapes after the first and second tapes have passed through the heater and to divert the optical fiber from between the first and second tapes.

11. A method for stripping a coating from an optical fiber, the method comprising:
inserting the optical fiber in a fiber insertion direction to an inserted position between first and second tapes, the optical fiber having a distal end;
pressing the inserted optical fiber between the first and second tapes at a pinch location using opposed heated rollers, the pinch location being offset from the distal end of the optical fiber by a desired strip length; and
moving the first and second tapes relative to the optical fiber in the fiber insertion direction toward the distal end of the optical fiber while concurrently pulling the inserted optical fiber from the inserted position in a fiber withdrawal direction opposite from fiber insertion direction thereby causing the coating to be stripped from a cladding of the optical fiber by the first and second tapes, wherein first and second tapes are pressed against the optical fiber at the pinch location by the opposed heated rollers during fiber withdrawal.

12. The method of claim 11, wherein the opposed heated rollers rotate as the first and second tapes are moved relative to the optical fiber.

13. The method of claim 11, wherein the optical fiber is one of a plurality of optical fibers arranged in parallel, and wherein coating material is concurrently stripped from claddings of all of the optical fibers by the first and second tapes.

14. The method of claim 11, wherein the optical fiber is pre-heated along the desired strip length prior to stripping of the optical fiber.

15. The method of claim 14, wherein the optical fiber is pre-heated by a heater positioned adjacent to the heated rollers, wherein the first and second tapes extend through the heater.

16. The method of claim 11, wherein initiation of withdrawal of the fiber is concurrent with initiation of moving of the first and second tapes.

17. The method of claim 11, wherein initiation of withdrawal of the fiber is after initiation of moving of the first and second tapes.

18. A method for stripping a coating from an optical fiber, the method comprising:
pressing the optical fiber between first and second tapes at a pinch location using opposed heated rollers; and
moving the first and second tapes relative to the optical fiber in a first direction while concurrently moving the optical fiber in a second direction opposite from the first direction thereby causing the coating to be stripped from a cladding of the optical fiber by the first and second tapes along a desired strip length, wherein first and second tapes are pressed against the optical fiber at the pinch location by the opposed heated rollers during fiber movement in the second direction.

19. A method for stripping a coating from an optical fiber, the method comprising:
inserting the optical fiber in a fiber insertion direction through a pinch location between first and second tapes and through a diverter used to separate the first and second tapes, wherein the diverter also diverts the inserted fiber away from the first and second tapes;
pressing the inserted optical fiber between the first and second tapes at the pinch location; and
stripping the optical fiber at a mid-span location of the optical fiber via contact between the first and second tapes and the optical fiber at the pinch location as the optical fiber is pulled in a fiber withdrawal direction opposite from the fiber insertion direction.

20. A method for stripping a coating from an optical fiber, the method comprising:
inserting the optical fiber in a fiber insertion direction to an inserted position between first and second tapes, the optical fiber having a distal end;
pressing the inserted optical fiber between the first and second tapes at a pinch location using opposed heated rollers, the pinch location being offset from the distal end of the optical fiber by a desired strip length; and
moving the first and second tapes relative to the optical fiber in the fiber insertion direction toward the distal end of the optical fiber thereby causing the coating to be stripped from a cladding of the optical fiber by the first and second tapes, wherein first and second tapes are pressed against the optical fiber at the pinch location by the opposed heated rollers during fiber stripping.
